(19) United States
(12) Patent Application Publication
(10) Pub. No.: US 2024/0245003 A1
(43) Pub. Date: Jul. 25, 2024

(54) MEASURING SEED COTTON PROPERTIES USING NEAR INFRARED SENSING

(71) Applicants: Deere & Company, Moline, IL (US); Iowa State University Research Foundation, Inc., Ames, IA (US)

(72) Inventors: Jeffrey S. WIGDAHL, Ames, IA (US); Jeffrey C. ASKEY, Boone, IA (US); John P. JUST, Boone, IA (US)

(73) Assignees: Deere & Company, Moline, IL (US); Iowa State University Research Foundation, Ames, IA (US)

(21) Appl. No.: 18/557,405

(22) PCT Filed: Jul. 27, 2022
(86) PCT No.: PCT/US2022/038451

§ 371 Date: Oct. 26, 2023

Related U.S. Application Data
(60) Provisional application No. 63/203,549, filed on Jul. 27, 2021.

(51) Int. Cl. A01D 46/08

(52) U.S. Cl. CPC A01D 46/085

(57) ABSTRACT

Systems and methods are provided for determining properties of seed cotton based on measurements from a near-infrared (NIR) sensor. The determined properties are indicative of a quality of the seed cotton. The NIR sensor is mounted on harvesting equipment to acquire quality data during harvesting. The quality data may be mapped to field location and/or forwarded on in preparation of further processing.

### CROSS-REFERENCE TO RELATED APPLICATIONS

This application claims the benefit of and priority to U.S. Provisional Application No. 63/203,549, filed on Jul. 27, 2021. The entirety of the aforementioned application is incorporated herein by reference.

### BACKGROUND

In many farming operations, it is desirable for the farm operator to know information about their crops, for example cotton crops, that are being harvested. Many of these properties may impact the value of the cotton. Usually, seed cotton is harvested and bundled together before being sent to a facility for further processing. Several properties associated with the processed cotton are measured, at a regional classing office, from samples removed from each lint bale.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Certain aspects and features of the present disclosure relate to determining properties of seed cotton using a near infrared (NIR) system including an NIR sensor. A NIR sensor can measure a wavelength profile of the seed cotton and the NIR system can generate a wavelength profile of the seed cotton. The NIR system can use the wavelength profile with one or more models (e.g., machine-learning models) to determine the properties of the seed cotton. For example, the moisture level of the seed cotton, the seed protein or oil content of the seed cotton, or the turnout constituents present in the seed cotton can be determined.

In some examples, the NIR sensor can be positioned at a facility near the field or offsite to determine the properties after the seed cotton has been removed from a harvester that collected the seed cotton. Alternatively, the NIR sensor can be mounted on the harvester to determine the properties of the seed cotton while it is being collected in the field.

In some examples, the determined properties can be associated with a location where the seed cotton was collected, so that a map indicating the properties of seed cotton at various locations in the field can be generated. The properties of the seed cotton can additionally or alternatively be used to make adjustments to variable parameters of the harvester, e.g., to improve performance of the harvester.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

Various non-limiting implementations are further described in the detailed description given below with reference to the accompanying drawings, which are incorporated in and constitute a part of the specification.

FIG. 1 illustrates a component diagram of an exemplary harvester (e.g. stripper) according to various aspects.

FIG. 2 illustrates a partial cutaway component diagram of a harvester (e.g. picker) according to one or more aspects.

FIG. 3 illustrates a harvester including a near infrared (NIR) system in accordance with various aspects.

FIG. 4 illustrates an example of a conveying duct including a (NIR) sensor that may be utilized with the harvester of FIG. 1 in accordance with some aspects.

FIG. 5 illustrates an example of a cleaner that may be utilized with the harvester of FIG. 1 in accordance with various aspects.

FIG. 6 is a flowchart illustrating a process for analyzing cotton in accordance with some aspects.

FIG. 7 is a simplified schematic diagram illustrating control aspects of the NIR system of FIG. 3 in accordance with some aspects.

FIG. 8 is a schematic diagram of an exemplary, non-limiting implementation of a cotton analysis system according to one or more aspects.

FIG. 9 is a schematic diagram of an exemplary, non-limiting implementation of a computing device for the cotton analysis system according to various aspects.

FIG. 10 is a simplified schematic diagram of an exemplary implementation for analyzing cotton in accordance with one or more aspects.

FIG. 11 is a flowchart of an exemplary, non-limiting process for analyzing cotton.

FIG. 12 is a flowchart of an exemplary, non-limiting process for controlling an agricultural machine based on cotton properties.

### DETAILED DESCRIPTION

Certain aspects and features of the present disclosure relate to a seed cotton measurement system that can include a near infrared (NIR) sensor. The NIR sensor can emit wavelengths of light in a specified range towards a sample of seed cotton. The NIR sensor can detect which wavelengths of light are being transmitted through and/or reflected back from the sample and send this data to a processor. The processor may generate a wavelength profile for the sample of seed cotton based on the data. The wavelength profile can be used to determine one or more properties of the seed cotton sample.

In some examples, the processor can determine the properties of the seed cotton based on the wavelength profile using a model, such as a machine-learning model. For example, a neural network can receive as input at least a portion of the wavelength profile and provide as output the properties of seed cotton. Examples of the properties of the seed cotton can include the turnout properties of the seed cotton, the seed properties of the seed cotton, and the moisture properties of the seed cotton.

The turnout properties of the seed cotton include the composition of the seed cotton (e.g., the ratio of lint, seed, and trash in the material). Traditionally, the turnout properties of the seed cotton are measured by measuring the total weight of the seed cotton (i.e. raw seed cotton, including trash) being fed into a cotton gin and measuring the weight of lint that exits the gin. However, the traditional method of measuring turnout properties only measures lint and other, with the other including the trash and seed of the seed cotton. Using an NIR system, the turnout properties can be determined at a greater level of granularity, so as to provide specific percentages of the seed, the trash, and the lint. Further, instead of having to wait for the seed cotton to be processed to determine the turnout properties thereof, at least part of the NIR system can be mounted to a harvester and the turnout properties can be determined while the cotton is being harvested from the field. For example, by using an NIR system to determine the turnout properties while the seed cotton is being harvested, an estimate of the lint yield is known prior to ginning to produce a lint yield map based on the location in the field from which the seed cotton was harvested.

The NIR system can additionally or alternatively determine the seed properties of the seed cotton. The seed properties indicate the portion of the seed that is protein and the portion of the seed that is other components. For example, the NIR system can determine a wavelength profile for the seed. At least a portion of the wavelength profile can then be fed into a model as mentioned above to predict the seed properties of the seed cotton. Similarly to the turnout properties, the seed properties of the seed cotton can be stored in a database and can be used to generate a map that correlates the seed properties of the seed cotton to a location where the seed cotton was harvested.

The NIR system can additionally or alternatively determine the moisture content of the seed cotton. Traditionally, the moisture content of seed cotton is measured using other sensing techniques and at a period in time after large quantities of seed cotton have been bundled together in a harvester. For example, the moisture content of an area may be measured together in a bundle, but the moisture content for an individual plant or individual rows is typically not determined. Some examples of the present disclosure can enable the moisture content of the seed cotton to be determined while the cotton is being harvested. For example, the moisture content of individual rows of seed cotton can be determined. Then, the moisture content of the seed cotton can be correlated with the location where the seed cotton was harvested to create a moisture map. Additionally, the moisture data can be stored in a database for later use.

In further examples, the NIR system can be used to determine various other properties of the seed cotton. For example, the color grade, the reflectance, the yellowness, the micronaire, the fiber length and staple, the length uniformity, the fiber strength, the leaf grade, the extraneous matter, and the trash can be determined for the seed cotton.

Any or all of the data (e.g., the properties and locations) associated with the seed cotton can be stored in a database on the harvester or elsewhere, such as in the cloud. The data can be accessed and used with one or more systems. For example, the data can be used to establish the settings of a cotton gin and thereby improve the efficiency of the cotton gin. The data can additionally or alternatively be used to determine categories of the seed cotton for separation of the seed cotton in the field or at the gin. Further, the data may be utilized to categorize lint content at a warehouse.

Some or all of the examples described herein may be used in conjunction with farming equipment to measure properties of seed cotton (e.g., raw cotton) while the seed cotton is being harvested. This is unlike traditional methods in which certain properties of cotton are measured after the cotton has been taking offsite and further processed, at least because these traditional methods are unable to correlate these properties with a location where the seed cotton was harvested. Additionally, some examples enable properties of seed cotton to be measured that currently cannot be measured with traditional methods, and can provide a higher degree of accuracy than traditional methods.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

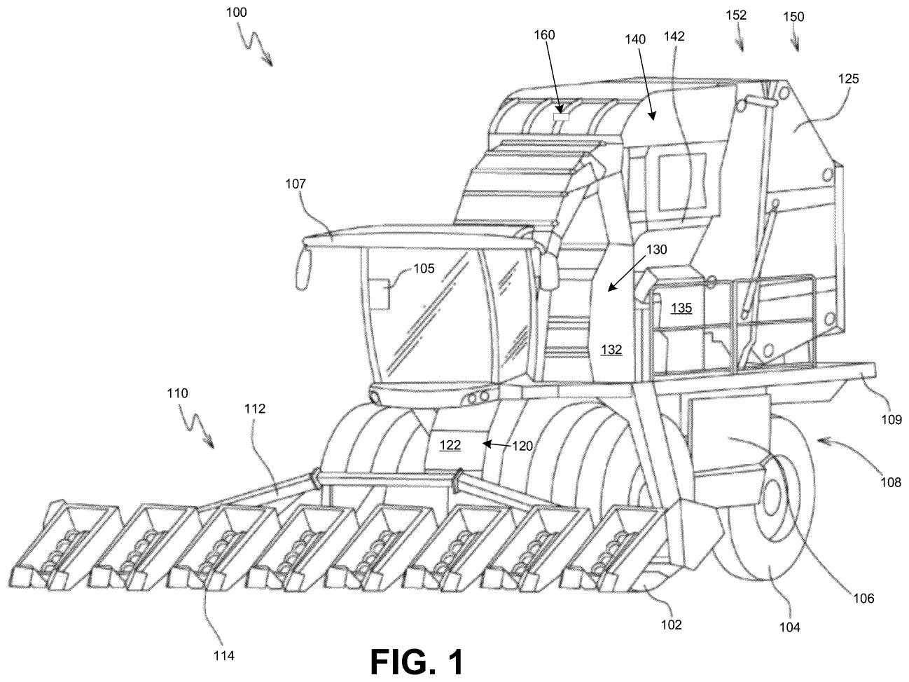

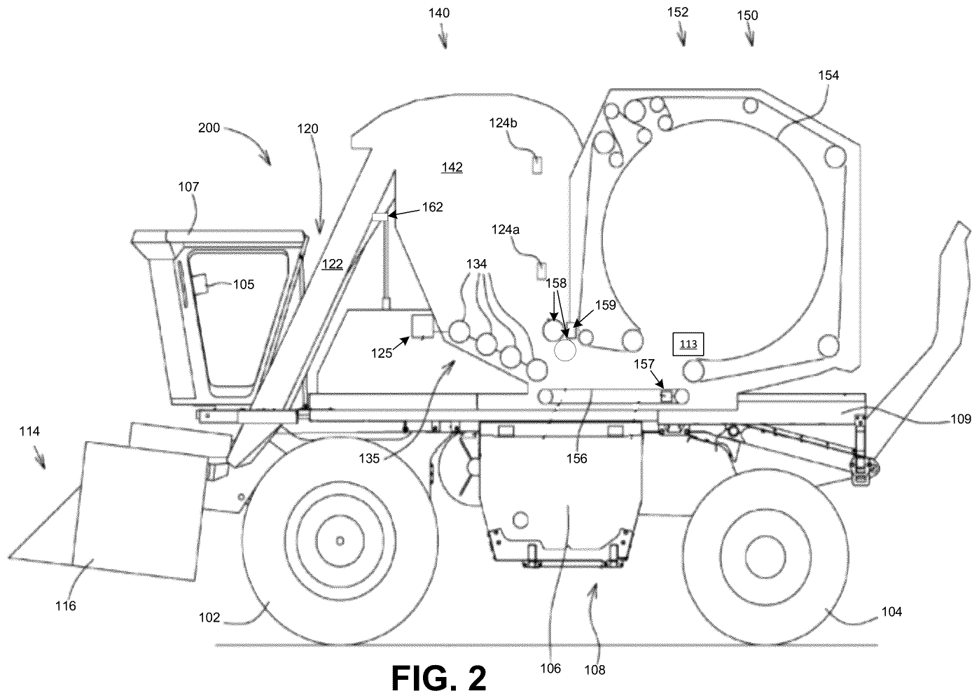

Referring now to FIGS. 1 and 2, which illustrate an example harvester vehicle 100. In this example, the harvester 100 is a cotton harvester (e.g., cotton picker, cotton stripper), but other types of harvesters are contemplated by this disclosure such as a combine.

The harvester 100 comprises a chassis 109 that is supported by front wheels 102 and rear wheels 104 although other support is contemplated such as tracks. The harvester 100 is adapted for movement through a field to harvest crops (e.g., cotton, corn, stover, hay, wheat, alfalfa, etc.).

An operator station 107 is supported by the chassis 109. An operator interface 105 is positioned in the operator station 107. A power module 108, such as an engine 106, can be supported below the chassis 109. Water, lubricant, and fuel tanks (not shown) may be supported in and on the chassis 109.

A crop harvesting device 114 is coupleable to the chassis 109. The crop harvesting device 114 can be configured to remove cotton from a field. The harvesting device 114 can comprise a cotton stripper header 112 (FIG. 1), one or more cotton picking units 116 (FIG. 2), or another harvesting structure (e.g., corn head, or other crop heads). Alternatively, the harvesting device 114 can be configured to remove corn, or other crops. The harvesting device 114 has different configurations (e.g., sizes, dimensions, etc.) depending on the type of crop being harvested and the manner of removing the crop from the field. In some implementations, the harvester vehicle 100 is a cotton stripper equipped with a crop harvesting device 114 that is adapted to remove, or strip, cotton from the plant.

In some implementations, the harvester vehicle 100 comprises a header system 110. The header system 110 can comprise a crop header component that operably harvests a crop from a target field, a hydraulic motor or electric motor (not shown), and one or more sensors. In some implementations, the crop header component can comprise a header 112 (e.g., a cotton stripper) and a header system load monitor. For implementations of the header system 110 that comprise a hydraulic motor, a hydraulic pump on the harvester vehicle 100 can drive the hydraulic motor on the header 112. In these implementations, the hydraulic motor can supply the power to rotate a shaft that drives individual harvesting units as well as cross augers that deliver cotton to the harvester vehicle 100. In other implementations, the electric motor can supply the power to rotate a shaft that drives individual harvesting units as well as cross augers that deliver cotton to the harvester vehicle 100.

The one or more sensors can be configured to monitor, or detect, a condition that is indicative of the power output of the hydraulic pump, hydraulic motor, or electric motor that drives the header system 110. In some implementations, the sensors are configured to monitor one or more of: the hydraulic pressure at the hydraulic pump of the header system 110, the electrical current through control solenoids of the hydraulic pump in the header system 110, and the rotation speed of a shaft that drives the harvesting units in the header system 110. That is, for example, the sensors can detect a condition that is indicative of the pressure, the current, and/or the speed to monitor the crop header component. In implementations that comprise an electric motor, the sensors can detect one or more conditions related to power such as, for example, current and/or voltage. For implementations comprising a hydraulic motor or an electric motor, the sensors can detect mechanical strain of the motor driving the crop header system 110.

In some implementations, the harvester vehicle 100 comprises an air system 120. The air system 120 can comprise a crop conveyor component that conveys the crop through the harvester vehicle 100, one or more sensors 160, 162, and a crop conveyor device (e.g., one or more air ducts and an air flow generator). In some implementations, the crop conveyor component can comprise one or more air ducts 122 and an air system load monitor, such as an air flow load monitor.

In some implementations, the air system 120 can be operably coupled to, and in communication with, the header system 110. In these implementations, the air duct 122 is coupled to, and aligned with, the header 112 so that the cotton stripped by the header 112 can be transported into the harvester vehicle 100 (e.g., a cleaner) through the air ducts 122 of the air system 120 powered by air flow (e.g., an air generator).

The one or more sensors 160, 162 can be configured to monitor air flow and/or crop mass flow in the air ducts 122 of the air system 120. In some implementations, one or more sensors can be positioned in the air ducts 122. As an example, a harvester 100, such as a cotton stripper, may include a plurality of mass flow sensors 160, such as four cotton mass flow sensors, that are mounted across the width of the air ducts 122. In other implementations, one or more sensors can be positioned adjacent the air ducts 122. As an example, a harvester 200, such as a cotton picker, may include a plurality of mass flow sensors 162 that are mounted behind the air ducts 122 with one cotton mass flow sensor mounted per row unit. The air flow, and/or crop mass flow, can be monitored using various types of sensors such as, but not limited to, an HDOC yield monitor, a vacuum sensor, an air speed sensor, etc. As an example, the HDOC yield monitor is a microwave based controller that bounces a signal off a flowing crop to detect a change in velocity with a slowing crop flow indicative of an air duct 122 being overloaded.

In some implementations, the harvester vehicle 100 comprises a cleaner system 130. The cleaner system 130 can comprise a crop cleaner component that operably cleans the harvested crop, a hydraulic motor or electric motor (not shown), and one or more sensors. In some implementations, the crop cleaner component can comprise a cleaner 132 and a cleaner system load monitor. The cleaner 132 can be provided to clean cotton from the cotton stripper header 112 by removing trash and debris. For implementations of the cleaner system 130 that comprise a hydraulic motor, a hydraulic pump on the harvester vehicle 100 can drive the hydraulic motor on the cleaner 132.

In some implementations, the cleaner system 130 can be operably coupled to, and in communication with, the air system 120 and to the header system 110, via the air system 120. In these implementations, the cleaner 132 is coupled to, and aligned with, the air duct 122 so that the cotton stripped by the header 112 can be transported into the cleaner 132 through the air ducts 122 of the air system 120 powered by air flow.

The one or more sensors can be configured to monitor, or detect, a condition that is indicative of the power output of the hydraulic pump, hydraulic motor, or electric motor that drives the cleaner system 130. In some implementations, the sensors are configured to monitor one or more of: the hydraulic pressure at the hydraulic pump of the cleaner system 130, the electrical current through control solenoids of the hydraulic pump in the cleaner system 130, and the rotation speed of a shaft of the cleaner 132 in the cleaner system 130. That is, for example, the sensors can detect a condition that is indicative of the pressure, the current, and/or the speed to monitor the crop cleaner component. In implementations that comprise an electric motor, the sensors can detect one or more conditions related to power such as, for example, current and/or voltage. For implementations comprising a hydraulic motor or an electric motor, the sensors can detect mechanical strain of the motor driving the crop cleaner system 130.

In some implementations, a crop receptacle 152 is coupleable to the air duct system 120. In some implementations, the crop receptacle 152 is a module builder 150 having at least one baler belt 154. As an example, a module builder can be used to build a module of the crop, such as a bale of cotton or hay/straw, etc. In other implementations, the crop may be ejected by the air duct system 120 into an internal hopper, and/or ejected from the harvester into an accompanying holding tank.

The harvester vehicle 100 comprises an accumulator system 140. The accumulator system 140 can comprise a crop accumulator component that operably, temporarily stores the harvest crop and one or more sensors 124. In some implementations, the crop accumulator component can comprise an accumulator 142 and an accumulator capacity monitor. The accumulator 142 is configured to receive cotton, or other crop, harvested by the cotton stripper header 112 (FIG. 1) or the cotton picking units 116 (FIG. 2).

In some implementations, the accumulator system 140 is operably coupled to, and in communication with, the cleaner system 130. In these implementations, the harvested crop can be transported (e.g., powered by air flow from an air generator) from the cleaner 132 into the top of the accumulator 142 such that the accumulator 142 fills from the bottom up.

With reference to FIG. 2, sensors 124, or feedback devices, can be coupled to the accumulator 142 to monitor an accumulator fill level and provide an accumulator fill level signal indicative of the fill level in the accumulator 142. In some implementations, the accumulator 142 has a low-level sensor 124a and a high-level sensor 124b. When the high-level sensor 124b is indicated, a signal is provided to the accumulator 142 to empty its crop contents. That is, for example, when the high-level sensor 124b detects the accumulator fill level exceeds (e.g., rises above) the pre-set sensor threshold level, an accumulator empty signal is propagated. In some implementations, the high-level sensor 124b can be configured, such as by its position in the accumulator 142, to be triggered before the accumulator 142 is completely full (e.g., having a built in buffer of extra crop accumulation space). Triggering of the low-level sensor 124a (e.g., IR sensor) indicates that the accumulator 142 has released a sufficient crop load, and should cease emptying its crop contents. That is, for example, when the low-level sensor 124a detects the accumulator fill level exceeds (e.g., drops below) a pre-set sensor threshold level, emptying of the accumulator 142 can cease. The low-level sensor 124a can be configured, such as by its position in the accumulator 142, to mitigate emptying of the crop from the accumulator 142 below a desired low level.

In some implementations, the accumulator system 140 can comprise other sensors to determine an accumulator fill rate and/or fill capacity. In some implementations, multiple sensors can be mounted at an inlet to the accumulator 142 to monitor mass flow rate (e.g., flow rate of the crop through the inlet, or other portions of the conveyor system) and accumulator fill rate. These sensors can be configured to measure the mass flow rate and to measure the time to fill the accumulator 142 between the low-level and high-level sensors 124a, 124b (e.g., accumulator fill rate) to determine yield.

In some implementations, it is beneficial to determine the mass in the accumulator 142 when the fill level is between the low-level and high-level sensors 124a, 124b. In these implementations, sensors can monitor the mass flow entering and exiting the accumulator 142 (e.g. which can be based on past accumulator cycles) and incorporate this data with additional timing data. As an example, a bale diameter can be used to determine a bale growth rate, and the bale growth rate can be used to determine the amount of mass from the size of the module diameter thereby creating a better estimation of mass in accumulator 142.

With continued reference to FIG. 2, a feeder 135 is coupleable to the chassis 109. The feeder 135 can be configured to receive cotton, or other crop, from the accumulator 142. The feeder 135 can comprise a plurality of meter rollers 134 configured to compress the cotton, or other crop, and transfer the cotton, or other crop, to the module builder 150 at a feed rate. A first motor 125 is positioned to rotate the plurality of meter rollers 134. The first motor 125 may be hydraulic or electric.

A plurality of beater rollers 158 can be configured to cooperate with the plurality of meter rollers 134 to transfer the crop, such as cotton, to the module builder 150 at the feed rate. A second motor 159 can be positioned to rotate the plurality of beater rollers 158. The second motor 159 may be hydraulic or electric.

A feeder belt 156 can be configured to receive crop from the plurality of meter rollers 134 and beater rollers 158 and transfer the crop to the module builder 150 at the feed rate. A third motor 157 is positioned to rotate the feeder belt 156. The third motor 157 may be hydraulic or electric.

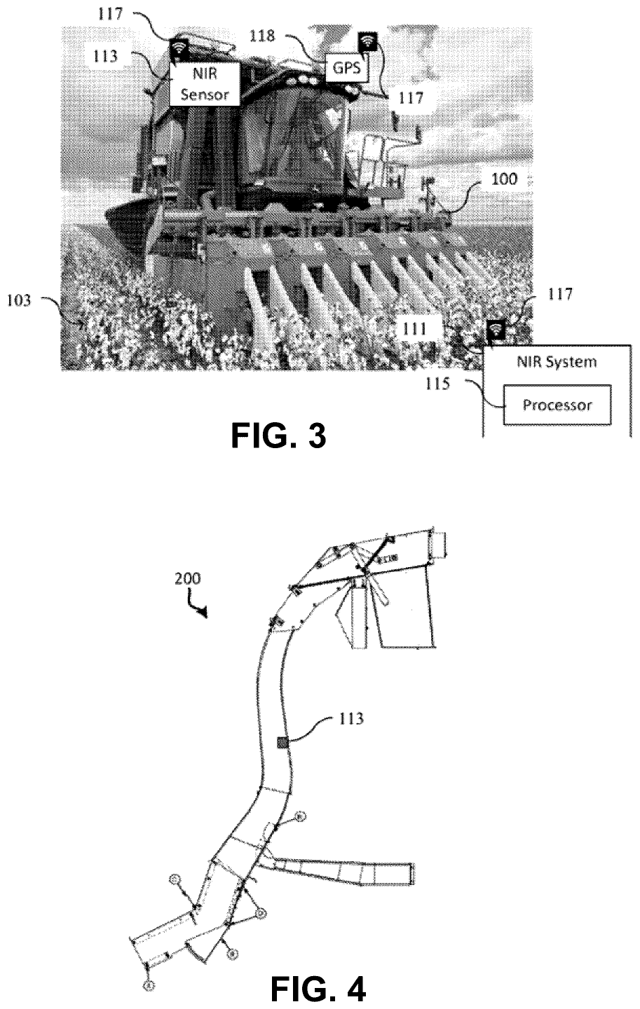

FIG. 3 illustrates a cotton harvester, such as harvester 100 from FIGS. 1 and 2, which can be used with an NIR system 111 to determine properties of seed cotton 103. The cotton harvester 100 can be or include a cotton stripper or a cotton picker. The NIR system 111 can include a NIR sensor 113 for measuring wavelengths of seed cotton 103, a processor 115 for determining properties of the seed cotton, and a communications interface 117 to facilitate communication between the NIR sensor and the processor. Some or all of the NIR system 111 can be mounted to the harvester 100. For example, the NIR sensor 113 can be mounted to the harvester 100 in a position for measuring wavelength properties of the seed cotton 103 being harvested. The NIR sensor 113 can measure the wavelength properties and transmit the wavelength properties to a processor 115 for determining certain other properties of the seed cotton 103. For example, the processor 115 can determine the turnout properties, the seed properties, and the moisture properties of the seed cotton 103 while the seed cotton is being harvested, based at least in part on the wavelength properties of the seed cotton measured using the NIR sensor 113. The processer 115 can be mounted on the cotton harvester 100 or positioned elsewhere, in which case the NIR system 111 may include one or more communications interfaces 117 that can facilitate the transmitting of information between the NIR sensor 113 and the processor 115. For example, the NIR sensor 113 can communicate with the processor 115 via Bluetooth, WIFI, or other radio interfaces. Additionally, the NIR system 111 or the harvester 100 can include a global positioning system (GPS) 118 for mapping the properties of the seed cotton 103 to locations where the seed cotton 103 was harvested. For example, the turnout properties, the seed properties, or the moisture properties can be mapped to locations associated with the seed cotton 103 to create a “live” (e.g., real time) map that shows various properties of the seed cotton being harvested. The GPS 118 may include one or more communications interfaces 117 for communicating with the NIR system 111. The data associated with the seed cotton 103 can also be used to make adjustments to components of the cotton harvester 100, or used to make predictions about the seed cotton 103. These aspects are described in greater detail below.

FIG. 4 illustrates a conveying duct 200 including an NIR sensor 113 that may be utilized with the cotton harvester 100 (“harvester”) of FIG. 1, 2, or 3. The NIR sensor 113 can be mounted in the conveying duct 200 to measure wavelength properties of the seed cotton while the seed cotton is still on the harvester, which in turn can be used by a processor to determine the moisture of the seed cotton. Traditionally, only the moisture of seed cotton is measured on the harvester using different measurement techniques, and the measurement is taken after the seed cotton has passed through the conveying duct, been cleaned, and has been packed together. Bundling the cotton together prevents traditional moisture sensing systems from generating a moisture map indicating the moisture content of the seed cotton at the locations where it was picked because seed cotton from an entire field or from multiple fields can be bundled together and measured at once. An NIR sensor 113 positioned in the conveying duct 200 is able to measure the wavelength properties of the seed cotton just after it has been harvested and before it has been packed together. The NIR sensor 113 can measure the wavelength properties of the seed cotton and transmit that information to a processor, which can determine the other properties of the seed cotton based on the wavelength properties and associated those other properties with a location where the seed cotton was harvested. The associated locations can be used to generate one or more maps showing the seed cotton properties and the location at which the seed cotton containing those properties was harvested. For example, the processor can determine the moisture of the seed cotton, and generate a moisture map, based on a wavelength profile of the seed cotton generated via the NIR sensor 113. The moisture map can show how the moisture properties of the seed cotton vary by location of the seed cotton plants.

Measuring properties of the seed cotton in the conveying duct 200 or elsewhere on the harvester, such as in a storage container, can also allow for adjustments to be made to components of the harvester based on the measured properties. For example, the properties of the seed cotton can be determined prior to the seed cotton being cleaned and those properties can be used to make adjustments to a cleaner mounted on the harvester. In other implementations, the properties of the seed cotton may be determined after the cotton has been cleaned by the harvester. This is further described below.

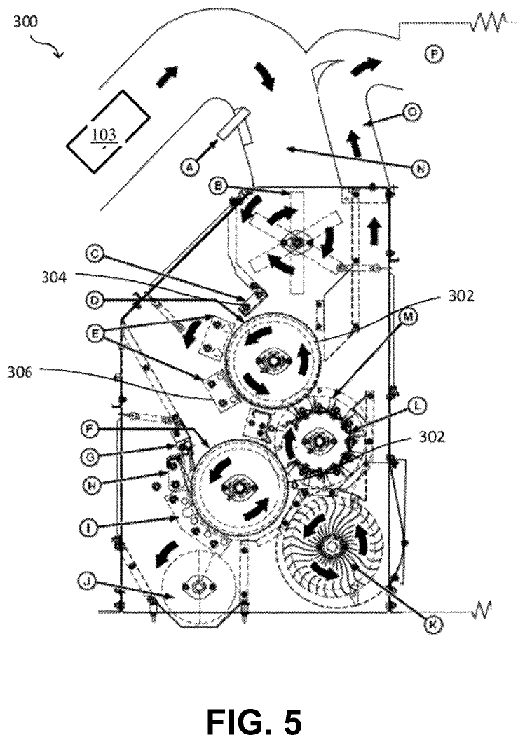

FIG. 5 illustrates an example of a cleaner 300 that may be utilized with the cotton harvester 100 of FIG. 1, 2, or 3. The cleaner 300 can include one or more rotating drums 302, one or more brushes 304, and one or more bars 306 positioned near the drums. A NIR system 111 can be used to determine properties of the seed cotton 103 prior to the seed cotton entering the cleaner 300. In other implementations, the NIR system 111 may be used to determine properties of the seed cotton as it exits the cleaner 300. For example, the NIR system 111 could measure the turnout properties or the composition of the seed cotton 103. Based on one or more properties of the seed cotton 103, the NIR system 111 can adjust (e.g., automatically) a component of the cleaner 300. The NIR system 111 can adjust the component by transmitting one or more control signals to the component or an actuator controlling a position of the component. Adjusting components of the cleaner 300 can improve the efficiency of the cleaner by reducing the amount of trash that is allowed to remain in the seed cotton 103 after cleaning. For example, if the turnout properties of the seed cotton 103 are measured and show a high percentage of trash, the NIR system can transmit control signals for causing the bars 306 to be moved closer to the drums 302 to knock more trash away. Conversely, if the turnout properties show a high percentage of lint in a trash trail, the NIR system can transmit control signals for causing the bars 306 to be retracted away from the drums 302, preventing lint from being knocked away in the cleaner 300. Additionally, the NIR system 111 can use previously collected properties to optimize the cleaner 300. For example, if seed cotton 103 is measured and is similar to seed cotton previously measured, the NIR system can initially configure the components of the cleaner 300 to have similar settings as were used to clean the previous cotton, and the NIR system can further refine the settings based on the output of the current cotton being cleaned.

In another example, the NIR system 111 may determine properties before cleaning and after cleaning to improve control of cleaner 300. For instance, turnout properties of the seed cotton 103 may be determined before and after cleaner 300. Through comparison of the turnout before and the turnout after, it may be determined how much trash is removed by cleaner 300. A control system associated with cleaner 300 can utilize this information to control operation of cleaner 300. For example, bars 306 may be moved toward or away from drum 302 based on the turnout comparison. It is to be appreciated that in addition to being indicative of how much trash is removed, measuring turnout before and after cleaner 300 may also be indicative of how much lint is lost through cleaning. Accordingly, the control system can control cleaner 300 to increase trash removal but limit the amount of lint lost.

According to another example, NIR sensor 113 may be incorporated into a baler of harvester 100. For instance, NIR sensor 113 may be positioned in module builder 150 as shown in FIG. 2. At this location, NIR sensor 113 can contact the seed cotton 103 to improve sensor readings. For instance, in some implementations, the NIR sensor 113 may be mounted to a movable arm and moved to contact the round module to acquire measurements. In further examples, the NIR sensor 113 may be position at a bottom portion of the module builder 150 to measure the round module at an outer perimeter regardless of a size of the round module.

In other implementations, an air gap may exist between the NIR sensor 113 and seed cotton 103. That is, direct contact is not present. In such arrangements, ambient light may be minimized to improve measurement quality. In this regard, the NIR sensor 113 may be positioned substantially anywhere in harvester 100. For instance, in some examples, the NIR sensor 113 may be positioned on the harvesting device 114 (e.g. the cotton stripper header 112 or cotton picking units 116). More generally, substantially any dark area of the harvester 100 may a suitable location for the NIR sensor 113. Still further, as moisture is a property measured with the NIR sensor 113 signals, the NIR sensor 113 may replace a moisture sensor included on harvester 100.

The location mapping of determined seed cotton properties, described above, may be performed in batches. For instance, a round module created by the module builder 150 may correspond to approximately one acre of seed cotton. As each load from the accumulator 140, measurements may be acquired with the NIR sensor 113. For example, after seed cotton 103 from the accumulator 140 is added to the building round module, this most recently added seed cotton 103 is located toward the outer perimeter of the round module. Accordingly, with the placement mentioned above, the NIR sensor 113 can acquire a reading of the accumulator load once added to the round module. These data can then be mapped to the corresponding area associated with the accumulator load.

Further data resolution may be gained by acquiring further measurements while the round module is stationary (e.g. between accumulator loads). In some examples, the round module may be jogged or index to acquire readings with the NIR sensor 113 from multiple segments. Thus, quality data acquired in aggregate for a round module may be coarsely mapped to an acre, and measurements of an accumulator load may be mapped to a subsection of an acre. With further measurements of a plurality of locations of the round module, greater resolution of location mapping is possible.

In another implementation, with the location mapping above (e.g. from round module or segments therefor to respective harvested location), additional data acquired after further processing can be linked back the harvested location. For instance, at a gin, a round module may produce 3 or 4 lint bales. The 3 or 4 lint bales may be mapped to the corresponding round module. Quality data associated with the lint bales can be correlated to the round module and, based on the mapping described above, further correlated to a harvested location. Such quality data can be aggregated with other information associated with the harvested location to correlate, for example, effects of agricultural operations to yield and/or quality.

In further examples, quality data mapped is round modules in accordance with the above techniques. With this mapping, randomness in grouping modules (e.g. for ginning) can be eliminated. Modules can be grouped based on the quality data. For instance, modules indicating higher quality can be grouped and processed together to improve total return. Higher quality, in some aspects, can refer to seed cotton properties indicative of higher lint yield. Certain thresholds or ranges can be predetermined for various properties. Specifically measured values for these properties can be indicators of quality, individually or in combination. Modules can be grouped in accordance with these indicators.

Another grouping of modules may be based on similarity of determined properties. This type of group allows the gin to be configured to process similar modules to further increase turnout efficiently. For example, the quality data for the modules is forwarded to the gin prior to processing. This enables the gin to configure accordingly. The grouping described above, avoid per module configuring, which may be time consuming. In general, the quality data is forwarded to the gin to enable the gin to optimize settings to achieve maximum throughput and efficiency, when processing the associated cotton.

Data acquired at the gin (e.g. classification data) can be utilized to further enhance the aspects herein. For instance, the data from the gin can be training data for the machine learning models utilized to process NIR sensor readings to determine seed cotton properties, and/or machine learning models that correlate determined properties to lint yield estimates.

Still further, the quality data may be provided to the operator (e.g. via the operator interface 105 in operator station 107). The operator and/or harvester 100 can adjust settings to adjust harvesting based on the data.

In some implementations, NIR sensor 113 data may be combined or supplemented with other sensors or imaging to improve measurement accuracy through data fusion. For instance, data from one or more of a camera, a yield monitor, a moisture sensor, etc. can be combined with NIR data to improve measurement accuracy.

In addition to combining data, the turnout data generated based on NIR data can be input to the yield monitor to provide more accuracy real-time yield estimates.

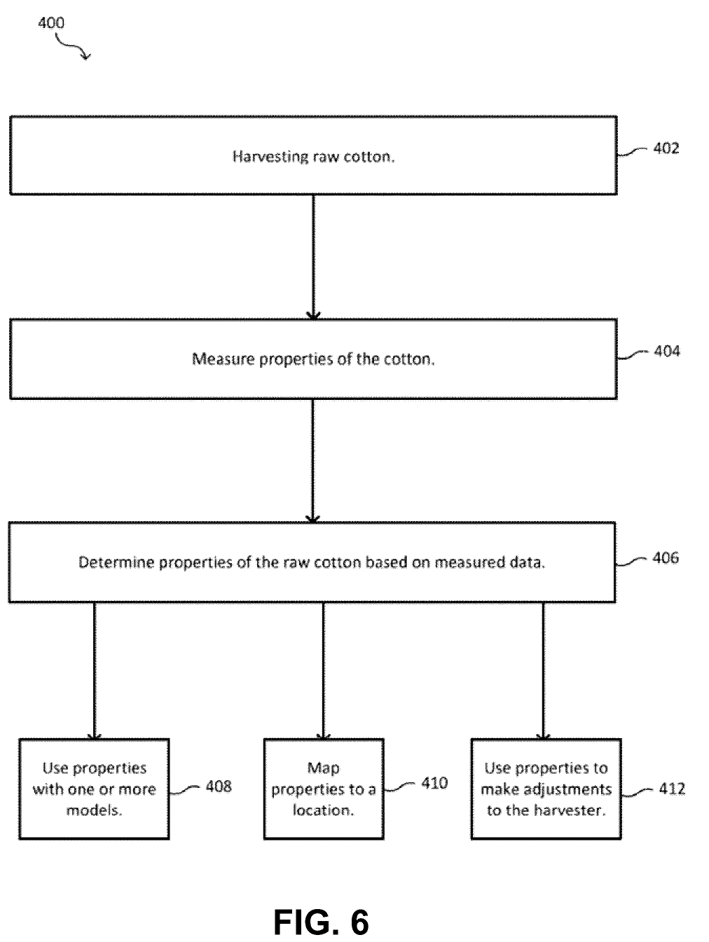

Turning now to FIG. 6, a flowchart illustrating a process 400 for analyzing cotton in accordance with some aspects of the present disclosure is shown. The process 400 begins at step 402, which involves harvesting seed cotton 103. The seed cotton 103 can be harvested by a harvester, for example, by the harvester 100 discussed in FIGS. 1, 2, and 3. The process 400 can then continue to step 404, which can involve measuring properties of the seed cotton 103. For example, the wavelength properties of the seed cotton 103 can be measured using a NIR sensor, for example NIR sensor 113 while a sample of seed cotton 103 is positioned on the harvester 100. According to various examples, the NIR sensor 113 may be an NIR camera, a multi-spectral camera, a hyperspectral camera. For instance, the NIR sensor 113 may be a camera that captures visible spectrum and non-visible spectrum. Such a device may be utilized for data fusion, which is described below.

The wavelength properties of the seed cotton 103 can indicate one or more other properties of the seed cotton. The wavelength properties can include information about what wavelengths of light the seed cotton 103 absorbs. The process 400 can next continue to step 406, which can involve the NIR sensor 113 transmitting the wavelength properties to a processor 115, which can determine the various other properties of the seed cotton 103. For example, the processor 115 can determine the turnout properties, the seed properties, or the moisture properties of the seed cotton 103. In some examples, the processor can determine these properties using one or more models configured to receive the wavelength properties (e.g., some or all of a wavelength profile containing the wavelength properties) as an input and output the properties as predictions. For example, a neural network can receive wavelength measurements associated with the seed cotton 103 as measured by an NIR sensor 113, and map those wavelength measurements to various other properties of the seed cotton. The NIR system 111 can then use the properties in any number of ways. The process 400 may also involve step 408, which can include the NIR system 111 updating (e.g., re-training) one or more existing models using the properties. Additionally or alternatively, the process 400 can involve step 410, which can include mapping the properties of the seed cotton 103 to locations at which the seed cotton was harvested. Additionally or alternatively, the process 400 can involve step 412, which can include making automatic adjustments to components of the harvester 100. One or more of steps 408 through 412 can be performed with a single set of data from the seed cotton 103. For example, the properties of the seed cotton 103 can be used to refine existing models or make new models, the properties can be mapped to a location to develop maps of the various cotton properties (e.g., for example a map of turnout properties), and can be used to make adjustments to improve the efficiency of a cleaner mounted on the harvester.

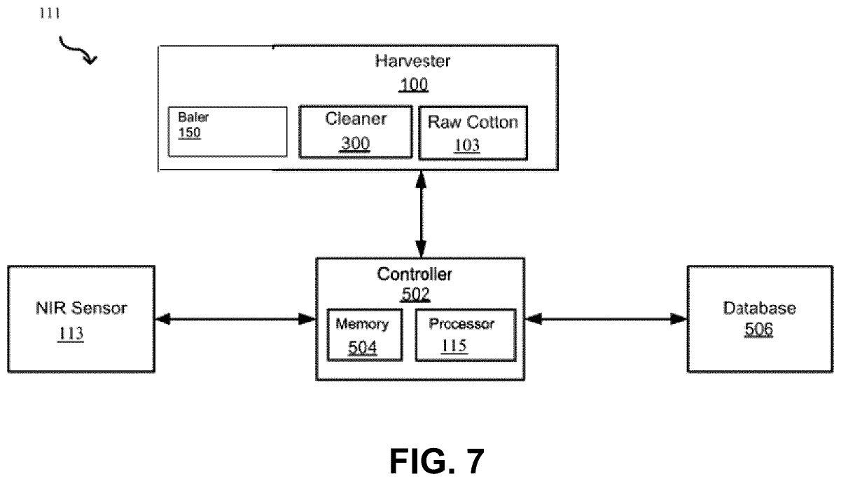

Turning now to FIG. 7, a simplified schematic diagram illustrating control aspects of the NIR system 111 of FIG. 3 is shown. The NIR system 111 can include a controller 502 containing memory 504 and a processor 115. The controller 502 can communicate with the NIR sensor 113, the harvester 100, and a database 506 via communications interface 117. The NIR system 111 can include the NIR sensor 113 to measure wavelength properties of seed cotton 103 and transmit the wavelength properties to the processor 115. The processor 115 can execute instructions stored in the memory 504 to determine certain other properties of the seed cotton 103 based on the wavelength properties from the NIR sensor 113. The properties of the seed cotton 103 can be stored in the database 506 for use by the NIR system 111 or another system. Additionally or alternatively, the properties of the seed cotton 103 can be used by the controller 502 to determine whether to transmit control signals to components of the harvester 100. For example, the controller 502 can transmit one or more control signals to the cleaner 300 to cause actuation of one or more components of the cleaner.

While the above examples are generally described in relation to seed cotton, other examples can be implemented using lint. For example, a NIR sensor 113 can determine a wavelength profile for lint and transmit that information to a processor, which in turn can determine one or more properties of the lint based on the wavelength profile.

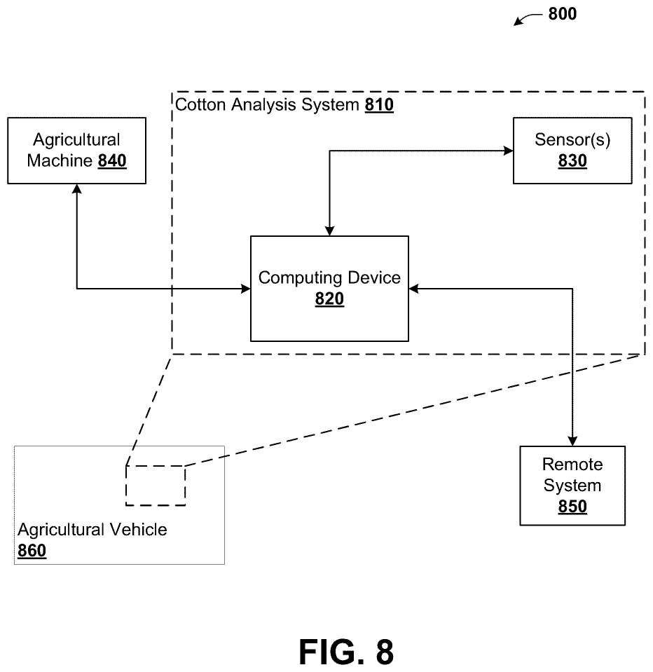

Referring now to FIG. 8, an agricultural system 800 for measuring one or more properties of seed cotton is depicted. In one example, the system 800 may be, partially or entirely, included in or utilized by an agricultural vehicle 860, such as a harvester, etc. As shown in FIG. 8, the system 800 includes a cotton analysis system 810 and, in some implementations, may additionally include an agricultural machine 840 and a remote system 850. The cotton analysis system 810 includes one or more sensors 830 and a computing device 820. It is to be appreciated that the cotton analysis system 810, in one example, is capable of determining one or more properties of seed cotton based on data acquired by the sensors 830. The cotton analysis system 810, in one example, may determine the cotton properties on-board the agricultural vehicle 860 and communicate the result to other devices such as remote system 850 and/or agricultural machine 840 (e.g. baler, cleaner, etc.). It is to be appreciated that agricultural machine 840 may be a component of agricultural vehicle 860. For instance, the agricultural machine 840 may be a baler or cleaner on a harvester (e.g. vehicle 860). In another example, the cotton analysis system 810 may jointly determine the seed cotton properties with assistance from the remote system 850. For instance, data acquisition may be performed by the cotton analysis system 810 onboard the agricultural vehicle 860 and remote system 850 may perform data analysis. Accordingly, the determination of seed cotton properties may be performed by either the cotton analysis system 810 and/or the remote system 850.

According to an aspect, the sensors 830 can acquire data associated with seed cotton. The data may be acquired while the agricultural vehicle 860 traverses a field. For instance, as described above, sensors 830 may acquire the data while the cotton is being harvested. Sensors 830, in some examples, may include near-infrared sensors and/or optical (e.g. RGB) sensors.

Data acquired by sensors 830 may be pre-processed to normalize or smooth the data. The data, with or without pre-processed, may be analyzed utilizing one or more models or analysis techniques to determine one or more properties of the seed cotton. According to some examples, these models or techniques may include regression analysis (e.g. partial least squares, or other regression analysis), component analysis, neural networks, classifiers, other machine learning techniques, or combinations of one or more techniques/models. These techniques may be configured, updated, or optimized based on later evaluation of cotton measured using system 800. For example, information from a gin or a USDA classifier may be used to tune data analysis.

The seed cotton properties may be communicated to the agricultural machine 860 or the remote system 850 for output to a user. The properties may be communicated to facilitate fleet management, gin configuration, data mapping, etc. The seed cotton properties may also be utilized to configure or control agricultural machine 140. In an example, a cleaner may be configured to improve trash removal and/or to limit a loss of lint.

The computing device 820, in one example, may analyze the sensor data to determine seed cotton properties. The analysis may be alternatively performed by the remote system 850. For instance, the computing device 820 can collect the sensor data and communicate the data to the remote system 850 for processing. Still further, the computing device 820 and the remote system 850 can work jointly. The remote system 850, for example, may provide storage, processing, and/or communication support to computing device 820. For instance, the remote system 850 may enable notifications to be communicated to third parties, extend machine learning capabilities to the computing device 820, and/or provide distributed computing resources to facilitate data processing across a plurality of nodes. Accordingly, it is to be appreciated that particular features, steps, or capabilities described in connection with the computing device 820, may be performed by the remote system 850 in the alternative.

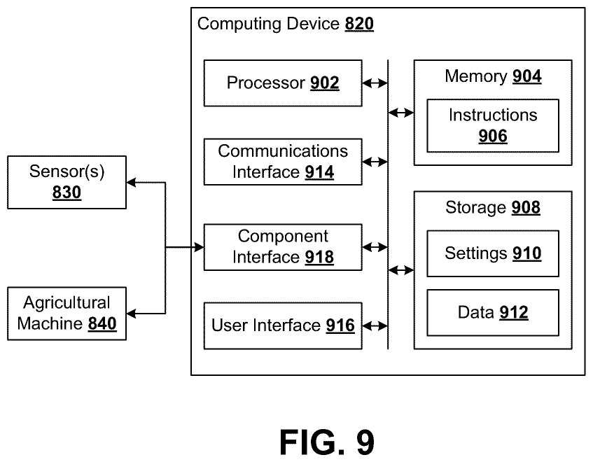

Turning to FIG. 9, illustrated is a schematic block diagram of an exemplary, non-limiting implementation for the computing device 820. Computing device 820 includes a processor 902 configured to execute computer-executable instructions 906 such as instructions composing an sensor data analysis and cotton properties determination process for the agricultural system 800. Such computer-executable instructions 906 can be stored on one or more computer-readable media including non-transitory, computer-readable storage media such as memory 904. Memory 904 can also include other data (working data or variables) or portions thereof during execution of instructions 906 by processor 902.

The computing device 820 can also include storage 908 that can be, according to an embodiment, non-volatile storage to persistently store instructions 906, settings 910 (e.g. configuration settings) and/or data 912 (e.g., operational data, history data, image data from sensors 830, learning models etc.).

The computing device 820 may also include a user interface 916 that comprises various elements to obtain user input and to convey user output. For instance, user interface 916 can comprise of a touch display, which operates as both an input device and an output device. In addition, user interface 916 can also include various buttons, switches, keys, etc. by which a user can input information to computing device 820; and other displays, LED indicators, etc. by which other information can be output to the user. Further still, user interface 916 can include input devices such as keyboards, pointing devices, and standalone displays.

The computing device 820 further includes a communications interface 914 to couple computing device 820, via the a communications network, to various devices such as, but not limited to, other computing devices 820, remote system 850, agriculture machine 840, agricultural vehicle 860, sensors 830, other controllers, servers, sensors, or Internet-enabled devices (e.g., IoT sensors or devices). Communication interface 914 can be a wired or wireless interface including, but not limited, a WiFi interface, an Ethernet interface, a Bluetooth interface, a fiber optic interface, a cellular radio interface, a satellite interface, etc.

A component interface 918 is also provided to couple computing device 820 to various components such as sensors 830 and/or agriculture machine 840. Component interface 918 can include a plurality of electrical connections on a circuit board or internal bus of computing device 820 that is further coupled to processor 902, memory 904, etc. Component interface 918, in another embodiment, can be an interface for a CAN bus of agricultural vehicle 860. Further, the component interface 918 can implement various wired or wireless interfaces such as, but not limited to, a USB interface, a serial interface, a WiFi interface, a short-range RF interface (Bluetooth), an infrared interface, a near-field communication (NFC) interface, etc.

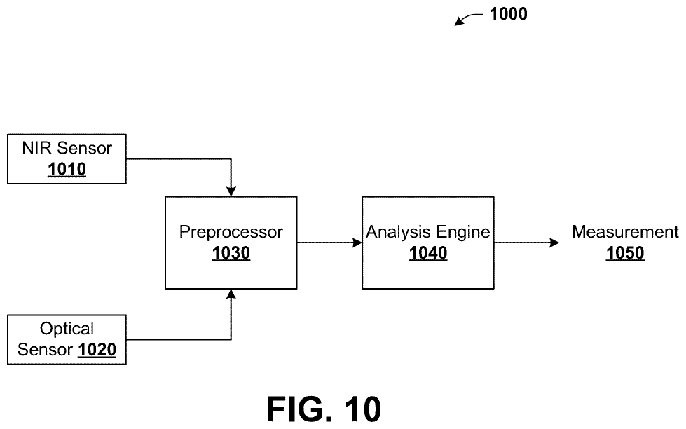

Turning now to FIG. 10, a simplified schematic diagram of an exemplary implementation of a cotton analysis system 1000 is depicted. System 1000, in some implementations, may be integrated with an agricultural vehicle, such as a harvester. System 1000, in such implementations, may operate while the vehicle performs operations.

As shown in FIG. 10, system 1000 may include an NIR sensor 1010 and an optical sensor 1020 (e.g. an RGB sensor or camera). To improve measurement accuracy, data acquired by NIR sensor 1010 and optical sensor 1020 may be combined. It is to be appreciated that additional sensors may also be utilized. With data fusion, data acquired on a sample by a plurality of disparate sensors is combined and/or jointly analyzed.

Data acquired from NIR sensor 1010 and optical sensor 1020 (and any other sensors) may be input to a preprocessor 1030 to smooth, normalize, or correlate the data (i.e. associate data from one sensor with corresponding data from another sensor). After preprocessing by preprocessor 1030, or optionally without preprocessing, the data is input to analysis engine 1040 to determine a measurement 1050. As described above, analysis engine 1040 may utilize various models or techniques such as, but not limited to, regression analysis (e.g. partial least squares, or other regression analysis), component analysis, neural networks, classifiers, other machine learning techniques, or combinations of one or more techniques/models.

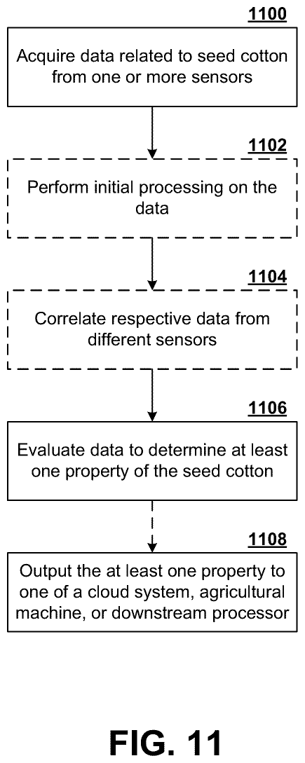

Turning to FIG. 11, a flowchart for a process for analyzing cotton is depicted. The process of FIG. 11 may be implemented by NIR system 111 and/or cotton analysis system 810. At 1100, data related to seed cotton is acquired from one or more sensors. The one or more sensors may include optical sensors, NIR sensors, or both. In an aspect, the sensors may be mounted on or integrated with an agricultural machine such as a harvester. Accordingly, the data may be acquired while cotton is actively being harvested. In doing so, the NIR system 110 or cotton analysis system 810 may control the machine to facilitate data acquisition or receive status signals from the machine to coordinate data acquisition. For instance, if the sensors are mounted in associated with a module builder, the system may stop a rotation of the module to acquire data if stationary data is desired. Alternatively, the system may take such sensor readings at a moment when the module is not rotating because an accumulator is being fed, for example. If continuous sensor readings are desired, the system may control data acquisition to occur when seed cotton is being conveyed to the module builder and, thus, when the module is rotating.

At step 1102, preprocessing may optionally be performed on the acquired data and, at step 1104, data fusion may be performed to correlate respective data from different sensors. At 1106, the acquired data is evaluated to determine at least one property of the seed cotton. Data analysis may use one or more technique or models to determine the at least one property of the seed cotton. In one example, a different model or technique (or different set of models and/or techniques) may be employed for different property to be determined. For example, turnout may be determined using one model or set of models and a moisture property may be determined using a different technique or set of techniques. At 1108, the at least one property is output to an agricultural machine, a cloud system, or a downstream processor (e.g. gin).

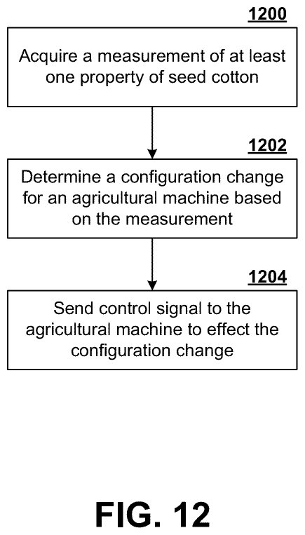

FIG. 12 depicts a flowchart for a process for controlling an agricultural machine based on cotton properties. At 1200, a measurement of at least one property of seed cotton is acquired. The measurement may be acquired according to the process of FIG. 11 and/or by NIR system 111 or cotton analysis system 810 described above. At 1202, a configuration change for an agricultural machine is determined based on the measurement. At 1204, a control signal is sent to the agricultural machine to effect the configuration change. According to an example, a measurement of a turnout property of the seed cotton may be acquired. The measurement may indicate a high quantity of trash in the seed cotton. Accordingly, a configuration change may be determined to increase cleaning of the seed cotton within an agricultural machine (e.g. within a cleaner of a harvest). Similarly, if the measurement indicates an increased loss of lint, the configuration change may be determined that decreases a cleaning intensity.

According to an aspect, an agricultural machine is described. The agricultural machine includes a sensor array and a computing device having a processor. The processor executes computer-readable instructions to: control the sensor array to measure seed cotton during harvesting by the agricultural machine to generate sensor readings; generate a profile for seed cotton based on sensor readings acquired from the sensor array; and determine one or more properties of the seed cotton based on the profile.

According to an example, the agricultural machine further includes a baler and the sensor array is mounted in the baler. In addition, the computing device executes instructions to control the sensor array to measure the seed cotton when a bale in the baler is stationary. In another example, the computing device executes instructions to control the sensor array to measure the seed cotton when the baler is active. In yet another example, the computing device executes instructions to rotate the bale when seed cotton is not be conveyed to the baler; and control the sensor array to measure the seed cotton measuring seed cotton while rotating.

In an example, the agricultural machine includes a conveying duct and the sensor array is mounted within the conveying duct. In another example, the agricultural machine includes an accumulator and the sensor array is mounted within the accumulator.

In further examples, the computing device further executes instructions to determine a location in a cotton field at which the seed cotton was collected; and store the location in association with the one or more properties determined. In addition, the computing device further executes instructions to adjust a setting for a component of the agricultural machine based on the one or more properties of the seed cotton.

Moreover, in other examples, the computing device further executes instructions to determine one or more predicted properties of the seed cotton based on the one or more properties. The one or more predicted properties include an estimate of respective quantities of trash, cotton, and seed present in the seed cotton. In addition, the one or more properties of the seed cotton include at least one of a moisture level in the seed cotton, turnout constituents present in the seed cotton, a seed protein level in the seed cotton, or oil content of the seed cotton.

According to other examples, the computing device further executes instructions to communicate quality data, based at least in part on the one or more properties. The quality data may be communicated, for example, to a gin to establish settings when processing the seed cotton associated with the quality data.

In other examples, the sensor array includes at least a near-infrared (NIR) sensor. In another example, the sensory array further includes an optical sensor. Further, the computing device is further configure to combine data on the seed cotton acquired by the NIR sensor with data on the seed cotton acquired by the optical sensor, wherein the one or more properties of the seed cotton are determined based on combined data.

In another example, a cotton analysis method is provided. The method includes acquiring sensor data, by a sensor array, related to seed cotton while the seed cotton is collected by an agricultural machine. The method also includes generating a profile for the seed cotton based on the sensor data acquired by the sensor array. The method further includes determining one or more properties of the seed cotton based on the profile. In addition, the method includes communicating the one or more properties to a gin to establish settings when processing the seed cotton associated with the one or more properties.

In an example, the method also includes adjusting a setting for a component of the agricultural machine based on the one or more properties of the seed cotton.

In a further aspect, a non-transitory, computer-readable storage medium is provided. The computer-readable storage medium has stored thereon computer-executable instructions for a cotton analysis application. The cotton analysis application, when executed by a processor, configures the processor to acquire sensor data, using a sensor array, related to seed cotton while the seed cotton is collected by an agricultural machine; generate a profile for the seed cotton based on the sensor data acquired by the sensor array; determine one or more properties of the seed cotton based on the profile; and adjust a setting for a component of the agricultural machine based on the one or more properties of the seed cotton.

While this specification contains many specifics, these should not be construed as limitations on the scope of the present disclosure, but rather as descriptions of features specific to particular aspects. Certain features that are described in this specification in the context of separate aspects can also be implemented in combination in a single implementation. Conversely, various features that are described in the context of a single implementation can also be implemented in multiple ways separately or in any suitable subcombination. Moreover, although features may be described above as acting in certain combinations, one or more features from a combination can in some cases be excised from the combination, and the combination may be directed to a subcombination or variation of a subcombination. Thus, particular aspects have been described but other aspects are within the scope of the disclosure.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such features may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

1. An agricultural machine, comprising:
a sensor array; and
a computing device having a processor executing computer-readable instructions to:
control the sensor array to measure seed cotton during harvesting by the agricultural machine to generate sensor readings;
generate a profile for seed cotton based on sensor readings acquired from the sensor array; and
determine one or more properties of the seed cotton based on the profile.

2. The agricultural machine of claim 1, further comprising a baler, wherein the sensor array is mounted in the baler.

3. The agricultural machine of claim 2, wherein the computing device executes instructions to control the sensor array to measure the seed cotton when a bale in the baler is stationary.

4. The agricultural machine of claim 2, wherein the computing device executes instructions to control the sensor array to measure the seed cotton when the baler is active.

5. The agricultural machine of claim 2, wherein the computing device executes instructions to:
rotate the bale when seed cotton is not be conveyed to the baler; and
control the sensor array to measure the seed cotton measuring seed cotton while rotating.

6. The agricultural machine of claim 1, further comprising a conveying duct, wherein the sensor array is mounted within the conveying duct.

7. The agricultural machine of claim 1, further comprising an accumulator, wherein the sensor array is mounted within the accumulator.

8. The agricultural machine of claim 1, wherein the computing device further executes instructions to:
determine a location in a cotton field at which the seed cotton was collected; and
store the location in association with the one or more properties determined.

9. The agricultural machine of claim 1, wherein the computing device further executes instructions to adjust a setting for a component of the agricultural machine based on the one or more properties of the seed cotton.

10. The agricultural machine of claim 1, wherein the computing device further executes instructions to determine one or more predicted properties of the seed cotton based on the one or more properties.

11. The agricultural machine of claim 10, wherein the one or more predicted properties include an estimate of respective quantities of trash, cotton, and seed present in the seed cotton.

12. The agricultural machine of claim 1, wherein the one or more properties of the seed cotton include at least one of a moisture level in the seed cotton, turnout constituents present in the seed cotton, a seed protein level in the seed cotton, or oil content of the seed cotton.

14. The agricultural machine of claim 1, wherein the computing device further executes instructions to communicate quality data, based at least in part on the one or more properties.

15. The agricultural machine of claim 1, wherein the sensor array includes at least a near-infrared (NIR) sensor.

16. The agricultural machine of claim 15, wherein the sensory array further includes an optical sensor.

17. The agricultural machine of claim 16, wherein the computing device is further configure to combine data on the seed cotton acquired by the NIR sensor with data on the seed cotton acquired by the optical sensor, wherein the one or more properties of the seed cotton are determined based on combined data.

18. A cotton analysis method, comprising:
acquiring sensor data, by a sensor array, related to seed cotton while the seed cotton is collected by an agricultural machine;
generating a profile for the seed cotton based on the sensor data acquired by the sensor array;
determining one or more properties of the seed cotton based on the profile; and
communicating the one or more properties to a gin to establish settings when processing the seed cotton associated with the one or more properties.

19. The cotton analysis method of claim 18, further comprising adjusting a setting for a component of the agricultural machine based on the one or more properties of the seed cotton.

20. A non-transitory, computer-readable storage medium having stored thereon computer-executable instructions for a cotton analysis application, the cotton analysis application, when executed by a processor, configures the processor to:
acquire sensor data, using a sensor array, related to seed cotton while the seed cotton is collected by an agricultural machine;
generate a profile for the seed cotton based on the sensor data acquired by the sensor array;
determine one or more properties of the seed cotton based on the profile; and
adjust a setting for a component of the agricultural machine based on the one or more properties of the seed cotton.
